(19) United States
(12) Patent Application Publication
(10) Pub. No.: US 2018/0292025 A1
(43) Pub. Date: Oct. 11, 2018

(54) MODULAR CONTROL DEVICE FOR SOLENOID VALVE ISLANDS, PARTICULARLY FOR THE ACTUATION OF ACTUATORS

(71) Applicant: METAL WORK S.p.A., Concesio (BS) (IT)

(72) Inventor: Diego ZOLA, Nave (BS) (IT)

(21) Appl. No.: 15/936,675

(22) Filed: Mar. 27, 2018

(30) Foreign Application Priority Data
Apr. 5, 2017 (IT) 102017000037262

(51) Int. Cl. F16K 37/00; G05D 7/06; F16K 31/06; G05B 19/418

(52) U.S. Cl. CPC F16K 37/0041; G05D 7/0635; G05B 2219/35029; G05B 19/41845; F16K 31/06

(57) ABSTRACT

A modular control device for solenoid valve islands, particularly for the actuation of actuators is described, having a control module for controlling a solenoid valve adapted for actuating an actuator, a communication module adapted to exchange information signals with such an actuator and an electrical connection module adapted to receive control signals from a user. The electrical connection module transmits the control signals to the control module and receives the information signals from the communication module. The electrical connection module has a processing and control unit configured to receive, store and process the information signals and the control signals.

### CROSS-REFERENCE TO RELATED APPLICATION

This application claims the benefit of Italian Patent Application No. 102017000037262 filed Apr. 5, 2017, the contents of which are incorporated herein by reference.

### FIELD OF INVENTION

The present invention relates to a modular control device for solenoid valve islands, particularly for the actuation of actuators.

### BACKGROUND OF THE INVENTION

A solenoid valve island comprises, as known, a base body on which a plurality of solenoid valves is arranged and with which the electronic power supply and control circuits for the solenoid valves themselves are associated, which therefore regulate the operation of an actuator, or of a plurality of actuators, by means of the aforementioned solenoid valves. Such power supply and control circuits are part of a modular control device for the solenoid valve islands.

Generally, a modular control device comprises an input module that operates as an interface with the user and receives the control signals from the user, and at least one valve control module, connected to the input module, which forwards the control signals to the solenoid valves.

The input module can in turn comprise an electrical connection module that acts as an interface with the user and a management module of the input and/or output signals coming from and/or directed to the actuator, in communication with the electrical connection module.

In the present description, the term module indicates the assembly of electronic circuits and electrical connection interfaces generally arranged on an electronic board. The various modules generally also have a containment body for the aforementioned electronic boards that constitutes the base of the modular control device.

Currently, in industry there is a great need to collect a large, and ever-increasing, amount of data generated and collected by the single machines that operate in industrial processes. Such data can be shared, for example, among the various machines present inside an industrial plant, or with the upper management levels thereof.

This, of course, needs the various machines to be capable of collecting, in general, the data on their life, productivity, maintenance, etc., and more in particular also the data on the operation of their single electromechanical components.

Currently, the solenoid valve islands tasked with controlling actuators are not capable of detecting the aforementioned data except, possibly, through special programmes loaded onto the external electronic terminals that operate them, such as programmable logic controllers (PLC), personal computers or industrial computers.

In order for such data to be collected by the PLCs, or by the computers, however, it is necessary for every single user to provide and load onto the PLC the specific programme capable of recovering, storing and supplying such data.

Such an operation, taking into account the fact that the various PLCs use different programming languages and rules from one another, is however highly costly in terms of human and economic resources.

Indeed, such an operation of providing and loading onto PLC, or onto PC, a programme capable of recovering and storing the data relative to the operation of the electromechanical components connected to a solenoid valve island, or to the operation of the island itself, should be carried out by a technician, case by case, on the single PLC, or PC, which operates a specific solenoid valve island, or possibly a group of solenoid valve islands.

### SUMMARY AND OBJECTS OF THE INVENTION

The aim of the present invention is to provide a modular control device for solenoid valve islands, particularly for the actuation of actuators, which overcomes the drawbacks of the prior art, making it possible to recover and store data relative to the life and to the operation of the solenoid valve islands and of the actuators connected to them.

Within this aim, an object of the present invention is to provide a control device for solenoid valve islands that is capable of carrying out a diagnostic of the operation of the solenoid valve islands and of the actuators connected to them.

Another object of the invention is to provide a control device for solenoid valve islands that makes it possible to recover and store data not easy to recover and store through the PLCs, or the PCs, tasked with controlling the modular control device itself.

Another object of the invention is to provide a modular device for solenoid valve islands that can be assembled in a flexible manner as a function of its specific uses.

A further object of the invention is to provide a modular device for solenoid valve islands that is capable of giving the greatest guarantees of reliability and safety in use.

Another object of the invention is to provide a modular device for solenoid valve islands that is easy to make and economically competitive compared to the prior art.

The aim outlined above, as well as the aforementioned objects and others that will become clearer hereinafter, are achieved by a modular device for solenoid valve islands, particularly for the actuation of actuators, as outlined in the claims.

### BRIEF DESCRIPTION OF THE DRAWINGS

The characteristics and advantages of a modular device for solenoid valve islands according to the present invention will become clearer from the following description, given as an example and not for limiting purposes, referring to the attached schematic drawings, in which:

FIG. 1 is a perspective view of a first embodiment of a modular control device for solenoid valve islands, according to the invention, associated with an actuator;

FIG. 2 is a perspective view of a second embodiment of a modular control device for solenoid valve islands, according to the invention;

FIG. 3 is a block diagram of the main components of a modular control device for solenoid valve islands, according to the invention.

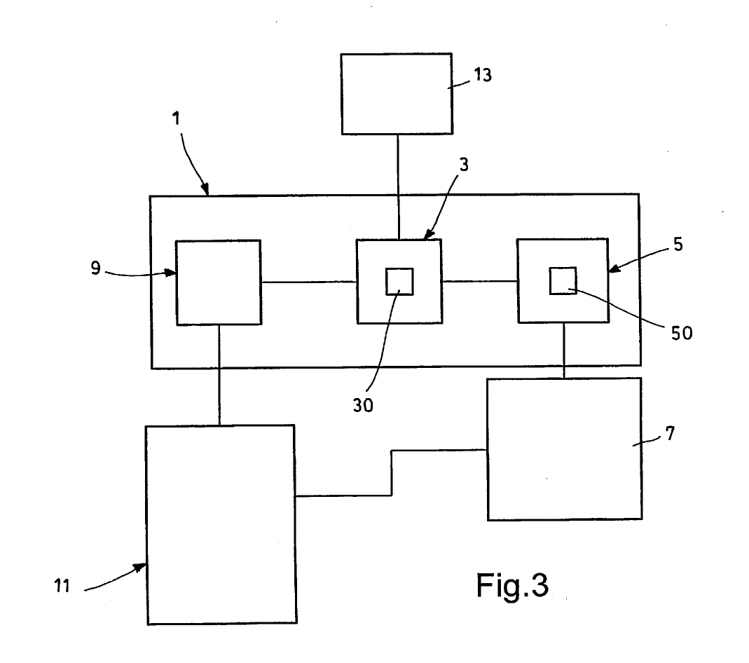

### DETAILED DESCRIPTION OF THE INVENTION

With reference to the above figures, a modular control device for solenoid valve islands, particularly for the actuation of actuators, globally indicated with reference numeral 1, comprises:
at least one control module 5 for controlling at least one solenoid valve 7 adapted for actuating at least one actuator 11;
at least one communication module 9 adapted to exchange information signals with such an actuator 11;
an electrical connection module 3 adapted to receive control signals from a user 13.

The electrical connection module 3 transmits the control signals to the control module 5 and receives the information signals from the communication module 9.

According to the invention, the electrical connection module 3 comprises a processing and control unit 30 configured to receive, store and process the information signals and the control signals.

Advantageously, the processing and control unit 30 is configured to transmit to the user 13 at least one among:
information signals,
control signals, and
data processed based on the information signals and the control signals, like for example diagnostic data of the operation of the modular control device 1 and/or of the solenoid valves 7 and/or of the actuators 11 connected to them.

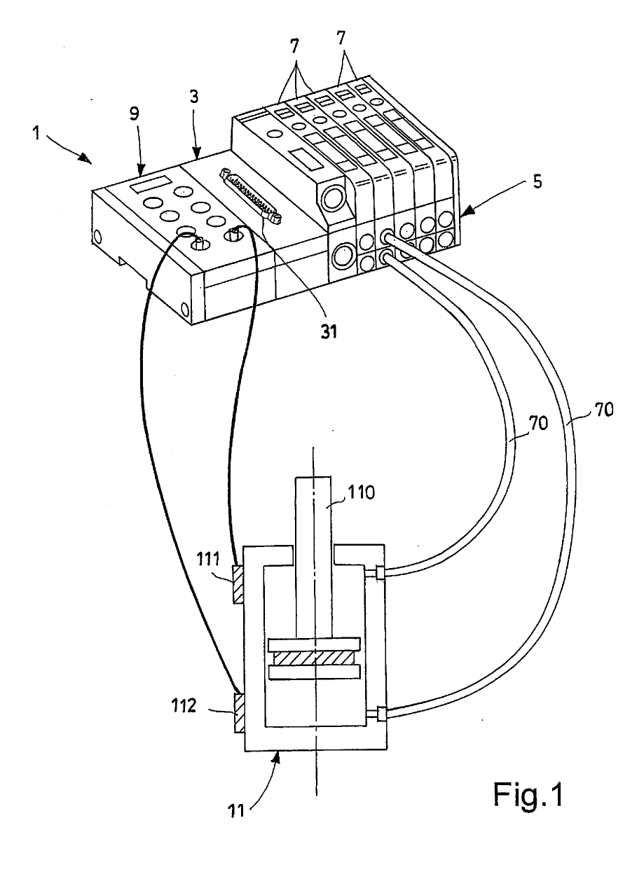

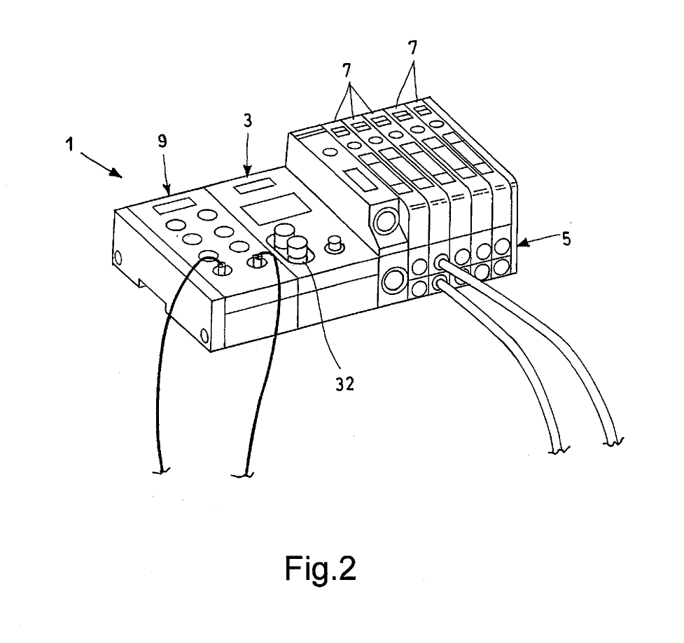

As illustrated in the examples of FIGS. 1 and 2, the control module 5 can control a plurality of solenoid valves 7, even of different types.

Advantageously, the electrical connection module 3 receives the control signals from the user 13 through an interface comprising an external electronic terminal, like for example a programmable logic controller (PLC), an industrial computer, a personal computer and/or other electronic devices.

Advantageously, the communication module 9 can be adapted for receiving input information signals, for example coming from the actuator 11.

Advantageously, the communication module 9 can be adapted for transmitting output information signals.

Advantageously, the communication module 9 can be adapted to exchange both input and output information signals, of the digital and/or analogue type.

Advantageously, the modular control device 1 can comprise a plurality of communication modules 9, where at least one communication module is adapted to exchange input information signals and at least one other communication module is adapted to exchange output information signals.

Advantageously, the electrical connection module 3 comprises at least one connector 31, 32 adapted for transmitting to the user 13 at least one among:
information signals,
control signals,
data processed based on the information signals and the control signals.

As illustrated in the embodiments of the device 1 shown respectively in FIGS. 1 and 2, the connector 31, 32 can be a connector of the parallel connector 31 type, like for example a multi-polar connector, or a connector of the series connector 32 type, like for example a fieldbus connector.

Advantageously, the electrical connection module 3 can comprise a wireless connection module for the connection with the external electronic terminal.

Advantageously, the processing and control unit 30 comprises a random access memory (RAM) and a read-only memory (ROM), preferably of the programmable and erasable read-only memory (EPROM) type.

The processing and control unit 30 is programmable by the user 13 through the aforementioned external electronic terminal.

Advantageously, the programme that makes it possible to receive, store, process and transmit the information signals, the control signals or the data processed can be loaded on the processing and control unit 30 in the production step, and/or in the use step, and/or in the maintenance step of the modular control device 1.

The electrical connection module 3, the control module 5 and the communication module 9 can be associated with one another in a modular manner.

Advantageously, the at least one solenoid valve 7 is adapted for actuating an actuator 11 comprising sensors configured to carry out a diagnosis of the operativity of the actuator 11 itself. In this case, the communication module 9 is adapted for receiving diagnostic signals coming from such sensors, and the processing and control unit 30 is configured to receive, store, process and transmit to the user 13 such diagnostic signals of the operativity of the actuator 11 and/or data processed based on such diagnostic signals.

More in particular, the at least one solenoid valve 7 can be adapted for actuating an actuator 11 comprising a movable piston 110 and at least one position sensor 111, 112 adapted for detecting at least one position of the movable piston 110. In this case, the communication module 9 is adapted for receiving the position signals coming from the position sensor 111, 112, and the processing and control unit 30 is configured to receive, store, process and transmit to the user 13 such position signals and/or data processed based on such position signals.

As schematically illustrated in FIG. 1, the actuator 11 comprises two position sensors 111 and 112, for example of the type of magnetic end stroke sensors, arranged at the ends of the stroke of the movable piston 110, inside the actuator 11.

A first position sensor 111 is capable of detecting the setting off of the movable piston 110, whereas a second position sensor 112 is capable of detecting the arrival of the movable piston 110.

Hereinafter an example of operation of the modular control device 1 for solenoid valve islands is described, with particular reference to the embodiment thereof illustrated in FIG. 1.

The fluid that passes through one of the solenoid valves 7 controls the movement of the actuator 11, which can be a hydraulic or pneumatic actuator. The position sensors 111 and 112 detect the two opposite end stop positions of the movable piston 110. The position signals are transmitted to the communication module 9 and from here to the electrical connection module 3 where the control and processing unit 30 is present.

The control and processing unit 30 is configured, amongst other things, also to associate a certain solenoid valve 7 with the corresponding actuator 11, and in particular with its position sensors 111 and 112. Such association can be carried out by the user 13, through the external electronic terminal.

When the solenoid valve 7 is actuated, the piston 110 starts to move, going away from the first position sensor 111 that is thus deactuated. The control and processing unit 30 measures the time that passes between the control signal at the solenoid valve 7 and the deactivation of the sensor 111: this time is the activation delay of the movement.

This data is stored in the control and processing unit 30, and possibly made available to the user 13.

This data can be used both for activities to verify or optimise the operation of the system as a whole, and for diagnostic activities.

In particular, if the delay is considered to be too high, the designer can decide to make corrective actions, for example changing the size of the solenoid valve 7 or the diameter of the tubes 70 that connect it to the actuator 11, in order to speed up the entire system.

Otherwise, the designer can take it into account to bring forward the subsequent steps of the work cycle, in order to compensate for this delay.

Moreover, the fact that the value of the delay increases over time can mean that one of the components of the system has deteriorated, for example the switching of the solenoid valve 7 has slowed down, or the friction of the movable piston 110 inside the actuator 11 has increased.

The movable piston 110 proceeds with its stroke until it reaches the end stop where the second position sensor 112 is actuated. The processing and control unit also stores this moment.

By comparing the moment at which the first sensor 111 was deactuated and that of actuation of the second sensor 112 one obtains the time taken by the movable piston 110 to carry out its stroke.

The processing and control unit 30 is capable of receiving from the user 13, and storing, the value of the stroke of the movable piston 110 of the actuator 11. Therefore, having the value of the stroke and of the time taken to carry it out, the processing and control unit 30 can calculate the speed of the movable piston 110.

These further data can be used in the start-up step of the system, since the user can verify whether the speed is in accordance with expectations and whether it respects possible design constraints.

Moreover, if, over time, the speed changes, it can mean that undesired events have occurred: a slowing can indicate wearing of the movable piston 110, whereas an acceleration can be dangerous for some members of the system.

Moreover, given that the processing and control unit 30 detects and stores the number of movements and the strokes, it is possible to know at any moment how many times an actuator has carried out a movement and how many kilometres it has travelled in total.

Advantageously, the control module 5 also comprises a processing and control unit 50 configured to receive, store, process and transmit the control signals and/or data processed based on at least such control signals.

Advantageously, the processing and control unit 50 of the control module 5 is configured to perform at least one operation selected in the group consisting of:
counting the number of actuations of the solenoid valve 7;
storing the number of actuations of the solenoid valve 7;
counting the working time of the solenoid valve 7.

Advantageously, the processing and control unit 50 of the control module 5 is configured to perform at least one operation selected in the group consisting of:
generating an alarm for an overload short-circuit of the solenoid valve 7;
generating an alarm for an open electrical contact for the solenoid valve 7;
generating an alarm for an off-specification power supply for the control module 5.

Advantageously, the processing and control unit 50 of the control module 5 is configured to perform an operation comprising the generation of an indicator adapted for indicating that the number of actuations of the solenoid valve 7 has exceeded a predetermined number of actuations stored in the processing and control unit 50.

In this way, the user 13 can know when the expected average life of a solenoid valve 7 has been exceeded and thus decide whether to replace such a solenoid valve 7 as a precautionary measure.

Advantageously, the processing and control unit 50 of the control module 5 also comprises a random access memory (RAM) and a read-only memory (ROM), preferably of the programmable and erasable read-only memory (EPROM) type.

The processing and control unit 50 of the control module 5 is programmable by the user 13 through the aforementioned external electronic terminal.

Advantageously, the programme that makes it possible to receive, store, process and transmit the control signals and/or the data processed from such control signals can be loaded on the processing and control unit 50 in the production step, and/or in the use step, and/or in the maintenance step of the modular control device 1.

In particular, the programmes respectively loaded on the processing and control unit 30, 50 that take care of carrying out the counting, the processing and the comparing described above, are activated whenever the modular control device 1 starts operating, in order, also, to store them.

Advantageously, all of the data detected and processed, over time, by the processing and control unit 30 of the electrical connection module 3 and by the processing and control unit 50 of the control module 5 can be stored in the respective processing and control units 30, 50 themselves to be recovered subsequently, for example when the modular control device 1 is brought to the manufacturer for maintenance or repair. In other words, the entire history of the operation of the modular control device 1 is stored in the control and processing unit 30, 50 and therefore it is possible to carry out diagnoses and maintenance having all of the data of interest to hand.

The modular control device for solenoid valve islands, particularly for the actuation of actuators, according to the present invention has the advantage of ensuring very advanced diagnostic performance without having to intervene, on each occasion, on the external electronic terminals (e.g. PLC, industrial computers, personal computers) that, as known, use different programmes, and have different programming languages and rules from one another.

Another advantage of the modular control device according to the invention consists of the fact that the data stored in the processing and control units present in the modular control device can be recovered if needed to obtain information on the components associated with the modular device itself, such as solenoid valves and actuators.

Yet another advantage of the modular control device, according to the invention, consists of the fact that it is possible to carry out diagnoses and monitoring of the operation of the components associated with the modular device itself in real time.

The invention thus conceived can undergo numerous modifications and variants, all of which are within the scope of the invention; moreover, all of the details can be replaced by technically equivalent elements. In practice, the materials used, as well as the sizes, can be whatever according to the technical requirements.

1) A modular control device for solenoid valve islands, particularly for the actuation of actuators, comprising:
a control module for controlling a solenoid valve adapted to actuate a actuator comprising a movable piston and a position sensor adapted to detect a position of said movable piston;
a communication module adapted to exchange information signals with said actuator,
an electrical connection module adapted to receive control signals from a user,
said electrical connection module transmitting said control signals to said control module,
said electrical connection module receiving said information signals from said communication module;
said electrical connection module comprising a processing and control unit configured to receive, store and process said information signals and said control signals,
said communication module being adapted to receive position signals coming from said position sensor, said processing and control unit being configured to measure and store the time that passes between a control signal to said solenoid valve and the deactivation of said position sensor, said measured time being the activation delay of the movement of said movable piston.

2) The modular control device according to claim 1, wherein there are two of said position sensors, a first position sensor being capable of detecting the setting off of the movable piston, and a second position sensor being capable of detecting the arrival of the movable piston, said control and processing unit being configured to store the activation moment of said second position sensor, the time that passes between the deactivation moment of said first position sensor and the activation moment of said second position sensor being the time taken by said movable piston to carry out its stroke.

3) The modular control device according to claim 2, wherein said control and processing unit is capable of receiving from the user, and storing, the value of the stroke of the movable piston, and of calculating the speed of the movable piston based on said received value and on the time taken by said movable piston to carry out its stroke.

4) The modular control device according to claim 1, wherein said control and processing unit detects and stores the number of movements and the strokes of said movable piston.

5) The modular control device according claim 1, wherein said processing and control unit is configured to transmit to said user at least one of said information signals, said control signals and data processed based on said information signals and said control signals.

6) The modular control device according to claim 5, wherein said electrical connection module comprises a connector adapted to transmit to said user at least one of said information signals, said control signals and said processed data, said connector being a parallel connector or a series connector.

7) The modular control device according to claim 1, wherein said processing and control unit comprises a random access memory (RAM) and a read-only memory (ROM).

8) The modular control device according to claim 1, wherein said control module comprises a processing and control unit configured to receive, store, process and transmit said control signals and/or data processed based on said control signals.

9) The modular control device according to claim 8, wherein said processing and control unit is configured to perform a operation selected in the group consisting of:
counting the number of actuations of solenoid valve;
storing the number of actuations of said solenoid valve; and
counting the working time of said solenoid valve.

10) The modular control device according to claim 8, wherein said processing and control unit is configured to perform an operation selected in the group consisting of:
generating an alarm for an overload short-circuit of said a solenoid valve;
generating an alarm for an open electrical contact for said a solenoid valve; and
generating an alarm for an off-specification power supply for said control module.

11) The modular control device according to claim 8, wherein said processing and control unit is configured to perform an operation comprising the generation of an indicator adapted to indicate that said number of actuations of said solenoid valve exceeded a predefined number of actuations stored in said processing and control unit.

12) The modular control device according to claim 7, wherein read-only memory (EPROM)is a programmable and erasable read-only memory (EPROM) type.
